(19) United States
(12) Patent Application Publication
(10) Pub. No.: US 2024/0410817 A1
(43) Pub. Date: Dec. 12, 2024

(54) CORROSION ESTIMATION METHOD AND SYSTEM

(71) Applicant: Nippon Telegraph and Telephone Corporation, Tokyo (JP)

(72) Inventors: Shota Oki, Tokyo (JP); Shingo Mineta, Tokyo (JP); Mamoru Mizunuma, Tokyo (JP); Masayuki Tsuda, Tokyo (JP)

(21) Appl. No.: 18/699,143

(22) PCT Filed: Nov. 10, 2021
(86) PCT No.: PCT/JP2021/041285

§ 371 Date: Apr. 5, 2024

(51) Int. Cl. G01N 17/00

(52) U.S. Cl. CPC G01N 17/006

(57) ABSTRACT

A correlation between environment data at a buried location and magnitude of a corrosion rate of each of a plurality of corrosion samples is obtained. A score based on the magnitude of the corrosion rate is set for the environment data at the buried location of each of the plurality of corrosion samples on the basis of the correlation between the environment data and the magnitude of the corrosion rate. The score set for the environment data is set as a score of the plurality of corresponding corrosion samples. A risk of corrosion of a metal structure to be buried in the buried locations of the plurality of corrosion samples is estimated on the basis of the score set.

### CROSS-REFERENCE TO RELATED APPLICATIONS

This application is a national phase entry of PCT Application No. PCT/JP2021/0041285, filed on Nov. 10, 2021, which application is hereby incorporated herein by reference.

### TECHNICAL FIELD

The present invention relates to a corrosion estimation method and system for estimating corrosion of a buried structure.

### BACKGROUND

Social infrastructure facilities that support our life have been rapidly developed since the high economic growth period. For this reason, it is said that in 2030, facilities that are 50 years old after construction occupy more than half of the entire facilities. To prevent failure of these aging infrastructure facilities, maintenance operation by periodic inspection has been conventionally performed. However, in recent years, inspection work has been delayed due to an increase in aging facilities and a decrease in inspection technicians, and appropriate measures cannot be taken for deterioration objects to be inspected, which may cause collapse or the like. Further, since visual inspection is difficult depending on an installation place of the facility, the inspection itself is not performed in many cases. A typical example of the place where the visual inspection is difficult is in soil.

In view of the above-described situation, in recent years, research for establishing a technique of predicting and estimating a deterioration state of facilities buried in soil has been actively conducted. When the technique of predicting and estimating a deterioration state is established, it becomes possible to select an object with severe deterioration and an object with slow deterioration without performing a field inspection. Safety is secured by preferentially updating the selected object with a fast progress in deterioration and efficiency in terms of cost is expected to be improved by using the object with a slow progress in deterioration for a longer time.

Examples of the above-described method of predicting and estimating deterioration include a soil corrosiveness evaluation method described in ANSI/AWWA AC 105/A 21.5-1999 “Polyethylene Encasement for Ductile-Iron Pipe Systems” that is a U.S. national standard. According to this ANSI standard, by using analysis results of five items of a soil resistance value, pH, a redox (oxidation-reduction) potential, moisture, and a sulfide, it is determined that corrosiveness is strong when a total of evaluation points is 10 points or higher.

### CITATION LIST

### Non Patent Literature

Non Patent Literature 1: M. Barbalat et al., “Electrochemical study of the corrosion rate of carbon steel in soil: Evolution with time and determination of residual corrosion rates under cathodic protection”, Corrosion Science, vol. 55, pp. 246-253, 2012.

### SUMMARY

### Technical Problem

However, even in the soil that acquired the total of 10 points or higher based on ANSI, there was an example in which corrosion deterioration was slight. Therefore, when the ANSI evaluation point and an actual corrosion amount were investigated, it was confirmed that there was no correlation between the ANSI evaluation point and the actual corrosion amount. Therefore, even if an evaluation method formulated as a standard is used, it is difficult to accurately predict and estimate soil corrosion.

It is known that soil corrosion progresses on the basis of an oxidation reaction of iron and a reduction reaction of dissolved oxygen as with corrosion in a neutral solution. However, the soil is a special environment in which three phases of a solid phase, a gas phase, and a liquid phase coexist, and it is considered that there are various factors contributing to a corrosion reaction (Non Patent Literature 1). In particular, solid phase information specific to soil is important information for understanding soil corrosion.

An example of the solid phase information that affects a state of water and oxygen that determines the presence or absence of occurrence of a corrosion reaction includes soil particle size distribution. The structure of particle gaps and particle packing density change depending on magnitude of the soil particle size and a difference in the particle size distribution, which greatly affects ease of supplying oxygen from a soil surface layer and a wetted area of a metal surface by water captured by a capillary phenomenon. Therefore, the soil particle size is the most effective environmental factor for inferring information of the liquid phase and the gas phase that control the presence or absence of corrosion occurrence for soil corrosion.

However, the solid-phase information handled by the ANSI standard is only the soil resistance value, which is one of factors by which the prediction and estimation of the soil corrosion is difficult in the ANSI standard. Further, the moisture is an indispensable factor for the progress of the corrosion reaction. Even in the ANSI standard, the moisture is adopted as one of the evaluation points, but it is difficult to predict and estimate corrosion by the soil moisture at a certain point of time when soil is collected.

The moisture in soil is supplied by rainfall in an actual environment, but the soil is dried in a period from when the rainfall occurs to when the next rainfall occurs, and a soil moisture content always varies because of repetition of wetting and drying. Such measurement of the change in the soil moisture content with time requires a long time depending on the soil, and thus it is difficult to measure the soil moisture content for all of a large number of soil samples. Therefore, in the prediction and estimation of corrosion by soil moisture, it is favorable to acquire more information regarding rain, such as an annual precipitation amount and a rainfall interval, for example. Further, the ANSI standard is optimized for underground steel structures in the United States, and does not reflect land parameters specific to each country, such as temperature and altitude.

Further, a method for predicting corrosion of a buried pipe using the ANSI evaluation points is known. To estimate the soil corrosion using the ANSI evaluation points, it is necessary to collect the soil in which a buried steel material is buried and calculate the ANSI evaluation points for each collected soil. That is, to estimate the soil corrosion by the above-described method, it is always necessary to collect the corresponding soil for each buried steel material and calculate the ANSI evaluation points for all the soils.

As described above, conventionally, there has been a problem that it takes time and effort to estimate corrosion of a buried structure, and it is not easy to accurately estimate corrosion.

Embodiments of the present invention have been made to solve the above problem, and an object of embodiments of the present invention is to accurately estimate corrosion of a buried structure without taking time and effort.

### Solution to Problem

A corrosion estimation method according to embodiments of the present invention includes: a first step of measuring corrosion thickness reduction amounts of a plurality of corrosion samples each including a metal structure buried in a different location; a second step of obtaining a corrosion rate from the measured corrosion thickness reduction amount and a buried period for each of the plurality of corrosion samples; a third step of obtaining a correlation between environment data at a buried location and magnitude of the corrosion rate of each of the plurality of corrosion samples; a fourth step of setting a score based on the magnitude of the corrosion rate for the environment data at the buried location of each of the plurality of corrosion samples on the basis of the correlation between the environment data and the magnitude of the corrosion rate; a fifth step of setting the score set for the environment data as a score of the plurality of corresponding corrosion samples; and a sixth step of estimating a risk of corrosion of a metal structure to be buried in the buried locations of the plurality of corrosion samples is buried on the basis of the score.

Further, a corrosion estimation system according to embodiments of the present invention includes a measurement device and an arithmetic device, in which the measurement device measures corrosion thickness reduction amounts of a plurality of corrosion samples each including a metal structure buried in a different location, and the arithmetic device includes a first arithmetic circuit that obtains a corrosion rate from the measured corrosion thickness reduction amount and a buried period for each of the plurality of corrosion samples, a second arithmetic circuit that obtains a correlation between environment data at a buried location and magnitude of the corrosion rate of each of the plurality of corrosion samples, a third arithmetic circuit that sets a score based on the magnitude of the corrosion rate for the environment data at the buried location of each of the plurality of corrosion samples on the basis of the correlation between the environment data and the magnitude of the corrosion rate, a fourth arithmetic circuit that sets the score set for the environment data as a score of the plurality of corresponding corrosion samples, and an estimation circuit that estimates a risk of corrosion of a metal structure to be buried in the buried locations of the plurality of corrosion samples on the basis of the score.

### Advantageous Effects of Embodiments of Invention

As described above, according to embodiments of the present invention, the score set for the environment data is set as the score of the plurality of corresponding corrosion samples, and the risk of corrosion is estimated on the basis of the score. Therefore, the corrosion of a buried structure can be accurately estimated without taking time and effort.

### BRIEF DESCRIPTION OF THE DRAWINGS

FIG. 1 is a flowchart for describing a corrosion estimation method according to an embodiment of the present invention.

FIG. 2 is a configuration diagram illustrating a configuration of a corrosion estimation system according to the embodiment of the present invention.

FIG. 3 is a configuration diagram illustrating a configuration of a measurement device 101 of the corrosion estimation system according to the embodiment of the present invention.

FIG. 4 is a characteristic graph illustrating an example of a result of performing correlation analysis between a corrosion parameter k and environment data.

FIG. 5 is a characteristic graph illustrating a relationship between the corrosion parameter k and a corrosion risk overall score determined for each corrosion sample.

FIG. 6 is an explanatory diagram illustrating a corrosion risk map for estimating a corrosion risk for each area.

### DETAILED DESCRIPTION OF ILLUSTRATIVE EMBODIMENTS

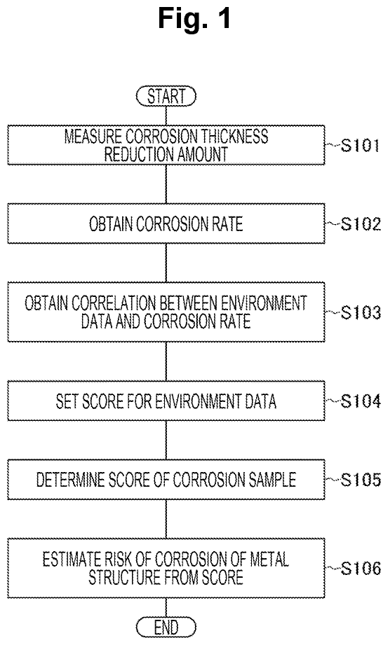

Hereinafter, a corrosion estimation method according to an embodiment of the present invention will be described with reference to FIG. 1. In this method, first, in first step S101, corrosion thickness reduction amounts of a plurality of corrosion samples each including a metal structure buried at a different location are measured. A difference between an initial thickness and a residual thickness of the metal structure can be set as the corrosion thickness reduction amount. Next, in second step S102, a corrosion rate is obtained for each of the plurality of corrosion samples from the measured corrosion thickness reduction amounts and a buried period.

Next, in third step S103, a correlation between environment data at the buried location and magnitude of the corrosion rate of each of the plurality of corrosion samples is obtained. The environment data of the buried locations of the plurality of corrosion samples are acquired, and the correlation between the acquired environment data and the magnitude of the corrosion rate is obtained.

Next, in fourth step S104, a score based on the magnitude of the corrosion rate is set for the environment data at the buried location of each of the plurality of corrosion samples on the basis of the correlation between the environment data and the magnitude of the corrosion rate. Here, the environment data of the buried locations of the plurality of corrosion samples are acquired, and the score is set for the acquired environment data.

Next, in fifth step S105, the score set for the environment data is set as a score of the plurality of corresponding corrosion samples. In fifth step S105, a total of scores each set in each of a plurality of pieces of the environment data in the buried location is set as the score (overall score) of the plurality of corresponding corrosion samples.

Next, in sixth step S106, a risk of corrosion of a metal structure to be buried in the buried locations of the plurality of corrosion samples is estimated on the basis of the score set as described above. Further, in fifth step S105, the risk can be estimated for each area.

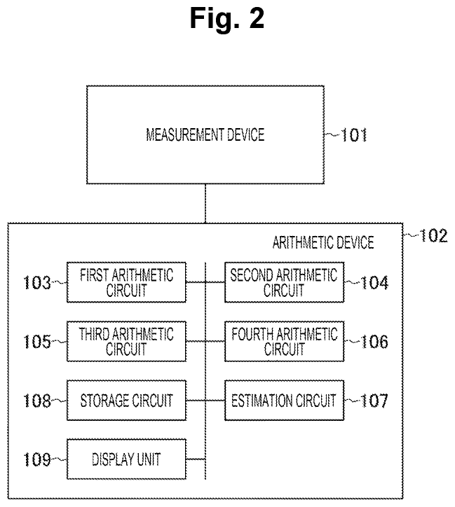

Next, a corrosion estimation system for implementing the above-described corrosion estimation method will be described with reference to FIG. 2. The system includes a measurement device 101 and an arithmetic device 102. Each operation of the measurement device 101 and the arithmetic device 102 is controlled by, for example, a controller (not illustrated). The measurement device 101 measures the corrosion thickness reduction amounts of a plurality of corrosion samples each including a metal structure buried at a different location.

The arithmetic device 102 includes a first arithmetic circuit 103, a second arithmetic circuit 104, a third arithmetic circuit 105, an estimation circuit 107, a storage circuit 108, and a display unit 109. When the measurement of the corrosion thickness reduction amount is performed by the measurement device 101, the arithmetic device 102 starts operation under the control of the controller (not illustrated).

The first arithmetic circuit 103 obtains the corrosion rate from the corrosion thickness reduction amount and the buried period for each of the plurality of corrosion samples. The obtained corrosion rate is stored in the storage circuit 108 along with identification information for identifying the corresponding corrosion sample.

The second arithmetic circuit 104 obtains the correlation between the environment data at the buried location and the magnitude of the corrosion rate of each of the plurality of corrosion samples is obtained. The arithmetic device 102 acquires the environment data of the buried locations of the plurality of corrosion samples, and the second arithmetic circuit 104 obtains the correlation from the acquired environment data.

For example, the environment data is stored in the storage circuit 108 in advance. Further, the environment data is stored in the storage circuit 108 in association with the identification information for identifying the corrosion sample. The set (given) score is stored in the storage circuit 108 in association with the corresponding corrosion sample.

The third arithmetic circuit 105 sets the score based on the magnitude of the corrosion rate for the environment data at the buried location of each of the plurality of corrosion samples on the basis of the correlation between the environment data and the magnitude of the corrosion rate.

The fourth arithmetic circuit 106 determines the score set for the environment data as the score of the plurality of corresponding corrosion samples. The fourth arithmetic circuit 106 sets the total of scores each set in each of a plurality of pieces of the environment data in the buried location as the score (overall score) of the plurality of corresponding corrosion samples.

The estimation circuit 107 estimates the risk of corrosion of a metal structure to be buried in the buried locations of the plurality of corrosion samples on the basis of the score (overall score) set as described above. Further, the estimation circuit 107 can perform the estimation for each area. The estimation circuit 107 estimates the risk from the score stored in the storage circuit 108.

The arithmetic device 102 is a computer device provided with a central processing unit (CPU).; a central processing unit), a memory, and the like. The CPU operates (executes a program) by the program expanded in the memory, whereby the above-described functions (second to fifth steps) are implemented. The arithmetic device 102 can also be constituted by a programmable logic device (PLD) such as a field-programmable gate array (FPGA). The program for implementing the operation of each step can be written in the FPGA by connecting a predetermined writing device.

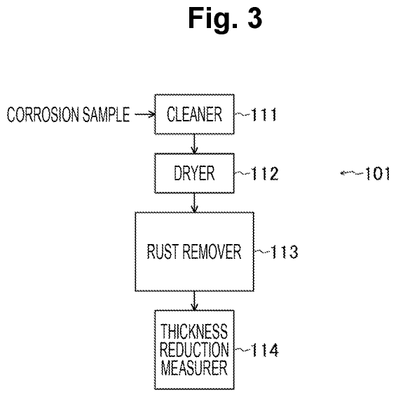

Next, the measurement device 101 will be described in more detail with reference to FIG. 3. The measurement device 101 includes a cleaner 111, a dryer 112, a rust remover 113, and a thickness reduction measurer 114.

The measurement device 101 measures the corrosion thickness reduction amount of a deteriorated buried steel material used in an actual environment. First, a corrosion sample for which the corrosion thickness reduction amount is to be measured is prepared and put into the cleaner 111 of the measurement device 101. The cleaner 111 removes soil and substances attached to a surface of the corrosion sample. The method of removing the substances attached on the surface by the cleaner 111 is not particularly limited as long as the method is capable of removing all the attached substances except a rust layer.

For example, the corrosion sample surface can be cleaned by the cleaner 111 including a high-pressure cleaner. For example, in a case where highly viscous mud adheres to the surface of the corrosion sample, a soil moisture content in the mud is set to 0% using the dryer 112 before cleaning, and then the dried mud can be dynamically removed by the cleaner 111 using a hammer or the like. Note that, in the case of dynamic removal, it is important to be careful not to deform the corrosion sample.

After the cleaner 111 completes the removal of the attached substances on the surface of the corrosion sample, the corrosion sample is sent to the rust remover 113. The rust remover 113 removes the rust layer attached to the surface of the corrosion sample. The mechanism (method) of removing the rust layer by the rust remover 113 is not limited as long as removal of the rust layer is possible. As a rust removal method, for example, a mechanical removal method or a pickling method can be used.

As the mechanical removal method, for example, a blank replica method in which after methyl acetate is added dropwise, rust is mechanically removed by an acetylcellulose film before the methyl acetate is volatilized, or a cathode electrolysis method in which hydrogen is generated in a dilute sulfuric acid or sodium hydroxide aqueous solution and the rust is removed by gas pressure can be used.

Further, as the pickling method, the rust can be removed using HCl alcohol with a concentration of 3% or a 50% aqueous solution of citric acid+50% aqueous solution of ammonium citrate. Note that, when HCl alcohol is used without using an inhibitor (corrosion inhibitor), pitting corrosion may occur in the corrosion sample itself, and thus attention is required for an immersion time.

After the rust removal of the corrosion sample by the rust remover 113 is completed, moisture on the surface of the corrosion sample is removed by the dryer 112. If the corrosion thickness reduction amount is measured by the thickness reduction measurer 114 in a state where moisture remains on the surface of the corrosion sample, an accurate value cannot be obtained depending on the measurement method. As a drying method by the dryer 112, for example, heat may be applied or pressure may be reduced. Note that, in the case where heat is applied, it is important to be careful not to thermally deform the corrosion sample.

After the pretreatment of the corrosion sample by the cleaner 111, the rust remover 113, and the dryer 112 is completed, the corrosion thickness reduction amount of the corrosion sample is measured by the thickness reduction measurer 114. The corrosion thickness reduction amount is actually calculated by measuring a residual thickness of the corrosion sample and subtracting the measured thickness from a design value. The residual thickness can be measured using, for example, a caliper. In the case where a caliper is used, measurement is performed about 10 times at an arbitrary location, and an average value thereof can be set as the residual thickness.

Further, an average residual thickness can be calculated by measuring an irregularity shape of the surface with a 3D macroscope. Further, a laser is radiated from above and below the corrosion sample using a laser measuring instrument, and the average residual thickness can be measured from a reflectance. In a case where a facility that may cause a serious accident due to perforation is set as an object, a minimum residual thickness can be measured instead of the average value of the residual thicknesses, and a maximum corrosion thickness reduction amount can be calculated. Note that, in the case of measuring the minimum residual thickness, it is not possible to use a caliper, and it is favorable to use a 3D macroscope or a laser measuring instrument. The measurement in the thickness reduction measurer 114 is not limited to the above-described method as long as a means capable of measuring the corrosion thickness reduction amount desired by a user is used.

The thickness reduction amount measured (measured) by the thickness reduction measurer 114 is sent to the arithmetic device 102 and stored in the storage circuit 108. As described above, in the arithmetic device 102, the first arithmetic circuit 103 calculates the corrosion rate from the corrosion thickness reduction amount and the buried period (the number of years elapsed from installation). For example, it is known that, in the case where the corrosion sample is a steel material, corrosion of the steel material progresses according to a power law model of “D=kTⁿ . . . (1)”. Note that, in Equation (1), D represents the corrosion thickness reduction amount [mm], k represents a corrosion parameter [mm/y], T represents elapsed years [y] of the buried steel material, and n represents a corrosiveness evaluation value of the material. Note that, since the value of n is empirically said to be 0.4 to 0.6, an intermediate value of 0.5 can be adopted.

The corrosion parameter k is calculated from the corrosion thickness reduction amount D measured by the thickness reduction measurer 114 and the elapsed years T of the corrosion sample checked in advance. From the unit [mm/y] of the corrosion parameter k, the corrosion parameter k can be treated as the corrosion rate. Further, since D=k is obtained by substituting 1 for T in Equation (1), it can be understood that the corrosion parameter k is the corrosion thickness reduction amount in the first year.

The measurement of the corrosion sample in the measurement device 101 is favorably performed for as many samples as possible for the steel material buried in the area where the corrosion risk is to be measured. To analyze the correlation between the corrosion thickness reduction amount and the environment data, it is favorable that at least 50 samples or more be measured by the measurement device 101.

Next, the second arithmetic circuit 104 analyzes the correlation between the corrosion thickness reduction amount measured by the measurement device 101 and the environment data. The corrosion parameter k obtained by the first arithmetic circuit 103 as described above is sent to the storage circuit 108. Further, published environment data is also stored in the storage circuit 108. The environment data corresponds to information of land and environment in which the corrosion sample is buried, and among them, the environment data corresponds to factors considered to be involved in the progress of soil corrosion.

For example, since repeated wetting and drying is essential for the progress of soil corrosion, information such as an average annual rainfall, an average annual rainfall frequency, an average annual rainfall interval, the number of times per year in which rainfall did not occur for 24 hours or more, and the number of times per year in which rainfall of 10 mm or more occurred can be acquired from radar AMeDAS information.

For example, as the solid phase information specific to soil corrosion, information such as a soil group indicating the type of soil, an earthy surface soil indicating the size of soil particles in a shallow portion, and an earthy surface soil indicating the size of soil particles in a deep portion can be acquired from soil map data sold by Japan Soil Association.

For example, to infer information of groundwater related to corrosion, a distance to a nearest neighboring water area can be acquired from an ESRI detailed map. For example, to determine whether a terrain is a terrain where water gathers, an altitude, a maximum inclination angle, a distance to a valley line, and a distance to a ridge line can be acquired from digital national land information. For example, to infer a drying rate of soil, annual sunshine hours can be acquired from the digital national land information.

As information related to the corrosion rate from the viewpoint of kinetics, an average annual temperature, a highest annual temperature, and a lowest annual temperature can be acquired from climate data. The environment data is not limited to the above-described information as long as parameters related to corrosion progress can be extracted.

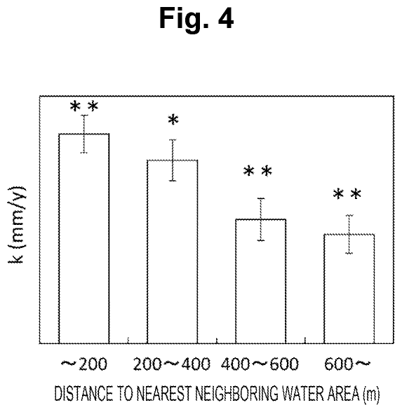

The second arithmetic circuit 104 analyzes the correlation between the corrosion parameter k (corrosion rate) stored in the storage circuit 108 and the environment data. For example, FIG. 4 illustrates an example of a result of performing a correlation analysis between the corrosion parameter k and the environment data for all of 117 corrosion samples collected from the Kanto area. FIG. 4 is a graph example illustrating a correlation between the corrosion parameter k and the distance to the nearest neighboring water area. From FIG. 4, it is possible to acquire a correlation that the average value of the corrosion parameters k is larger as the distance to the nearest neighboring water area is shorter.

Note that, in each bar graph of FIG. 4, a standard deviation is obtained and an error bar is added. As illustrated in FIG. 4, the correlation with the corrosion parameter k is analyzed for each environment data in the storage circuit 108. Note that, in the example of FIG. 4, the analysis is performed by dividing the distance to the nearest neighboring water area every 200 m, but the distance may be subdivided every 100 m or every 300 m. The user can arbitrarily determine how to divide each environmental data.

The third arithmetic circuit 105 sets a score (corrosion risk score) in the environment data from the correlation between the corrosion parameter k analyzed (obtained) by the second arithmetic circuit 104 and the environment data as described above. The third arithmetic circuit 105 assigns the corrosion risk score to each environment data. For example, in the example of FIG. 4, it can be seen that the value of the corrosion parameter k is larger as the distance to the nearest neighboring water area is shorter. As a result, a higher risk score is assigned to the environment data having a larger value of the corrosion parameter k.

Score distribution may be determined by, for example, the magnitude of the average value of the corrosion parameters k. Further, a t-test may be performed for each bar graph, and the corrosion risk score may be inclined depending on whether there is a significant difference. For example, referring to FIG. 4, when a t-test was performed for the average value of the corrosion parameters k at the distance of 200 m or less to the nearest neighboring water area, and the average values of the corrosion parameters k at the distance of 400 to 600 m to the nearest neighboring water area and of the corrosion parameter k at the distance of 600 m or more to the nearest neighboring water area, a p value as a significant difference determination value was 0.01 or less.

This indicates that populations of both two groups of the distances to the nearest neighboring water areas of 200 m or less and 400 to 600 m, and of 200 m or less and 600 m or more are significantly different. In general, it is determined that there is a significant difference when the p value is 0.05 or less, and “*” is assigned to the bar graph when p<0.05, “**” is assigned to the bar graph when p<0.01, and “***” is assigned to the bar graph when p<0.001. In FIG. 4, “***” at p<0.001 has no object and is not illustrated. Since it is determined that the smaller the p value, the larger the significant difference, the corrosion risk score can be inclined according to the number of “*”.

On the basis of the above, regarding the result of FIG. 4, the corrosion risk score of 5 points can be assigned to the distance to the nearest neighboring water area of 200 m or less, the corrosion risk score of 3 points can be assigned to the distance of 200 to 400 m, the corrosion risk score of 2 points can be assigned to the distance of 400 to 600 m, and the corrosion risk score of 1 point can be assigned to the distance of 600 m or more. For the environment data that has no correlation with the corrosion parameter k, all the corrosion risk scores can be set to 0 points. The method of assigning the corrosion risk score is not limited to the above-described method as long as the correlation between the corrosion parameter k and the environment data is reflected.

After the corrosion risk score is set for each environment data by the third arithmetic circuit 105, the fourth arithmetic circuit 106 adds the corrosion risk scores of all the environment data together to calculate the corrosion risk overall score, and determines the corrosion risk overall score as the score of the corresponding corrosion samples.

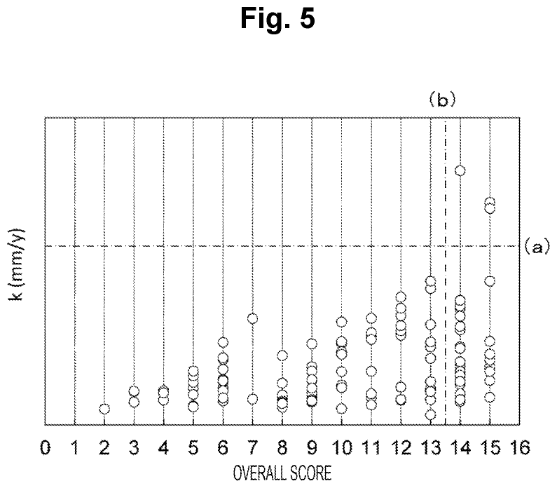

FIG. 5 is a graph example illustrating a relationship between the corrosion parameter k and the corrosion risk overall score determined for each corrosion sample. Note that the corrosion risk overall score in FIG. 5 is an example of a result obtained by adding the scores of seven environment data including the distance to the nearest neighboring water area in FIG. 4. It can be seen that for the corrosion samples with a prominently large corrosion parameter k, 15 points and 14 points with a large corrosion risk overall score are obtained. Further, in the example of FIG. 5, no corrosion samples with severe corrosion deterioration are not included in all the corrosion risk overall scores of 13 points or less.

The estimation circuit 107 sets a risk criterion for selecting a facility to be renewed from the graph of the corrosion parameter k and the corrosion risk overall score of the corrosion sample of FIG. 5. First, when the object facility needs to be renewed is set by how much the thickness is reduced. For example, in a case where a plate thickness of the facility handled in FIG. 5 is 3.2 mm, it is assumed that a need for renewal is determined at the time when the thickness is reduced by 1.6 mm, which is half of the plate thickness. Further, since the elapsed years of the collected corrosion sample was up to 45 years, the elapsed years was set to 45 years.

In light of the above description, when 1.6 mm is substituted for D and 45 y for Tin Equation (1), k is calculated as 0.349 mm/y. This value corresponds to the line illustrated in (a) in FIG. 5, and it can be recognized (estimated) that the corrosion sample having a value of the corrosion parameter k larger than (a) is a sample with severe corrosion deterioration.

Next, in FIG. 5, how many points or more the corrosion risk overall score actually becomes the object to be renewed is set. Since the points of the corrosion samples exceeding (a) fall within 14 points and 15 points, the facilities corresponding to the corrosion samples having the corrosion risk overall score of 14 points or more can be set as the objects to be renewed. The corrosion samples having the score of 14 points or more correspond to the points plotted on the right side of the line of (b) of FIG. 5, and the facilities corresponding to the corrosion samples having the scores on the right side of the line of (b) of FIG. 5 are the objects to be renewed.

The operation in a risk criterion setting unit 33 is completed when the line of (b) of FIG. 5 is set.

The estimation circuit 107 sets the corrosion risk on the basis of the calculated corrosion risk overall score. FIG. 5 is a schematic graph illustrating the corrosion risk for each area obtained from the corrosion risk overall score. First, the corrosion risk can be given for each corrosion risk overall score.

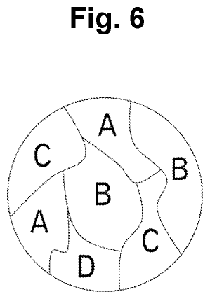

For example, risk A at the corrosion risk overall score of 14 to 15 points, risk B at 10 to 13 points, risk Cat 5 to 9 points, and risk D at 0 to 4 points can be determined in descending order of the corrosion risk. As a result, as illustrated in FIG. 6, a corrosion risk map for estimating the corrosion risk for each area can be created. This estimation result is displayed on the display unit 109, for example, and can be visually recognized by the operator. By using such an estimation result, it is possible to estimate the corrosion risk of the buried steel material in a wide range without performing any measurement and analysis including the corrosion thickness reduction measurement.

All of the 117 corrosion samples plotted in FIG. 5 have elapsed years of 40 years or more, and are all collected as a result of being recognized as the objects to be renewed. In the corrosion risk estimation device 1, it can be determined that it is sufficient to renew only 30 objects out of the total of 117 objects when only the objects having the risk overall score of 14 points or more is set as the objects to be renewed. Among them, it is possible to completely renew the objects to be renewed with severe corrosion deterioration, that is, the samples exceeding the reference value (a) in FIG. 5.

Therefore, in view of the example of FIG. 5, by using embodiments of the present invention, it is possible to secure the safety by renewing the steel material buried in the same area without overlooking the objects with severe corrosion deterioration, and it is also possible to secure economic efficiency while eliminating waste by using the safe objects for a longer time because the total number of renewal is reduced by 75% of a conventional case.

FIG. 5 is an example, and by increasing the environment data to be handled and improving the inclination of the corrosion risk scoring, it becomes possible to estimate the corrosion risk with more accuracy, and it becomes possible to secure the above safety and economic efficiency.

Regarding the estimation result in the corrosion risk estimation device 1, the corrosion risk overall score is calculated for each facility and the corrosion risk can be evaluated without analyzing the correlation of the corrosion risk in the future in the case of the facility installed in the same area belonging to the same population in which the correlation between the corrosion parameter K and the environment data is secured. Further, in a case where the environment of the buried area is greatly different, it is favorable to acquire the correlation between the corrosion parameter k and the environment data again and derive a highly compatible corrosion risk estimation result for the area.

As described above, according to embodiments of the present invention, the score set for the environment data is set as the score of the plurality of corresponding corrosion samples, and the risk of corrosion is estimated on the basis of the score. Therefore, the corrosion of a buried structure becomes able to be accurately estimated without taking time and effort. According to embodiments of the present invention, for example, it becomes possible to create a corrosion risk map for each area as long as the environment data can be acquired, and it becomes possible to estimate the corrosion risk of the steel material buried in the area in the map without requiring acquisition of the environment data as long as the corrosion risk map can be obtained.

### REFERENCE SIGNS LIST

101 Measurement device
102 Arithmetic device
103 First arithmetic circuit
104 Second arithmetic circuit
105 Third arithmetic circuit
106 Fourth arithmetic circuit
107 Estimation circuit
108 Storage circuit
109 Display unit

1-8. (canceled)

9. A method comprising:
measuring a respective corrosion thickness reduction amount for each of a plurality of corrosion samples, each of the plurality of corrosion samples including a metal structure, and each of the plurality of corrosion samples being buried in a different location;
obtaining a respective corrosion rate from the respective corrosion thickness reduction amount and a respective buried period for each of the plurality of corrosion samples;
obtaining a respective correlation between environment data at a respective buried location and a magnitude of the respective corrosion rate of each of the plurality of corrosion samples;
setting a respective score for the environment data at the respective buried location of each of the plurality of corrosion samples based on the magnitude of the respective corrosion rate and based on the respective correlation between the environment data at the respective buried location and the magnitude of the respective corrosion rate;
setting an overall score of the plurality of corrosion samples, wherein the overall score is based on the respective score for the environment data at the respective buried location of each of the plurality of corrosion samples; and
estimating a risk of corrosion of a metal structure to be buried in buried locations of the plurality of corrosion samples based on the overall score.

10. The method according to claim 9, wherein setting the overall score of the plurality of corrosion samples comprises setting a total of each score for the environmental data at the respective buried location of each of the plurality of corrosion samples as the overall score of the plurality of corrosion samples.

11. The method according to claim 10, further comprising acquiring the environment data of the respective buried location of each of the plurality of corrosion samples, wherein obtaining the respective correlation between the environment data at the respective buried location and the magnitude of the respective corrosion rate of each of the plurality of corrosion samples comprises obtaining the respective correlation based on the acquired environment data of the respective buried location of each of the plurality of corrosion samples.

12. The method according to claim 11, further comprising estimating a risk of corrosion for each area of a plurality of areas.

13. The method according to claim 9, further comprising acquiring the environment data of the respective buried location of each of the plurality of corrosion samples, wherein obtaining the respective correlation between the environment data at the respective buried location and the magnitude of the respective corrosion rate of each of the plurality of corrosion samples comprises obtaining the respective correlation based on the acquired environment data of the respective buried location of each of the plurality of corrosion samples.

14. A corrosion estimation system comprising:
a measurement device configured to measure a respective corrosion thickness reduction amount for each of a plurality of corrosion samples, each of the plurality of corrosion samples including a metal structure, and each of the plurality of corrosion samples being buried in a different location;
a memory comprising instructions; and
one or more processors in communication with the memory, wherein the one or more processors execute the instructions to:
obtain a respective corrosion rate from the respective corrosion thickness reduction amount and a respective buried period for each of the plurality of corrosion samples;
obtain a respective correlation between environment data at a respective buried location and a magnitude of the respective corrosion rate of each of the plurality of corrosion samples;
set a respective score for the environment data at the respective buried location of each of the plurality of corrosion samples based on the magnitude of the respective corrosion rate and based on the respective correlation between the environment data at the respective buried location and the magnitude of the respective corrosion rate;
set an overall score of the plurality of corrosion samples, wherein the overall score is based on the respective score for the environment data at the respective buried location of each of the plurality of corrosion samples; and
estimate a risk of corrosion of a metal structure to be buried in buried locations of the plurality of corrosion samples based on the overall score.

15. The corrosion estimation system according to claim 14, wherein the instructions to set the overall score of the plurality of corrosion samples comprises instructions to set a total of each score for the environmental data at the respective buried location of each of the plurality of corrosion samples as the overall score of the plurality of corrosion samples.

16. The corrosion estimation system according to claim 15, wherein the instructions include further instructions to:
acquire the environment data of the respective buried location of each of the plurality of corrosion samples, wherein the instructions to obtain the respective correlation between the environment data at the respective buried location and the magnitude of the respective corrosion rate of each of the plurality of corrosion samples comprises instructions to obtain the respective correlation based on the acquired environment data of the respective buried location of each of the plurality of corrosion samples.

17. The corrosion estimation system according to claim 16, wherein the instructions further include instructions to estimate a risk of corrosion for each area of a plurality of areas.

18. The corrosion estimation system according to claim 14, wherein the instructions include further instructions to:
acquire the environment data of the respective buried location of each of the plurality of corrosion samples, wherein the instructions to obtain the respective correlation between the environment data at the respective buried location and the magnitude of the respective corrosion rate of each of the plurality of corrosion samples comprises instructions to obtain the respective correlation based on the acquired environment data of the respective buried location of each of the plurality of corrosion samples.

19. The corrosion estimation system according to claim 14, wherein the measurement device comprises:
a cleaner configured to clean each of the plurality of corrosion samples.

20. The corrosion estimation system according to claim 19, wherein the measurement device further comprises:
a dryer configured to dry each of the plurality of corrosion samples after cleaning each of the plurality of corrosion samples.

21. The corrosion estimation system according to claim 14, wherein the measurement device further comprises:
a rust remover configured to remove rust from each of the plurality of corrosion samples after cleaning each of the plurality of corrosion samples.

22. The corrosion estimation system according to claim 21, wherein the measurement device is configured to measure the respective corrosion thickness reduction amount for each of a plurality of corrosion samples after removing the rust from each of plurality of corrosion samples.
